(19) United States
(12) Patent Application Publication
(10) Pub. No.: US 2018/0175701 A1
(43) Pub. Date: Jun. 21, 2018

(54) FASTENING SYSTEM FOR THE AIR DEFLECTOR OF A ROTATING ELECTRIC MACHINE AND ROTATING ELECTRIC MACHINE USING THE SAME

(71) Applicant: Weg Equipamentos Elétricos S.A., Jaraguá do Sul (BR)

(72) Inventors: Marcelo VERARDI, Joinville (BR); Jose Roberto DOS SANTOS, Joinville (BR); Ricardo WILGES, Jaraguá do Sul (BR); Talita WAJCZYK, Joinville (BR); Thiago Schwinden LEAL, Jaraguá do Sul (BR)

(21) Appl. No.: 15/848,839

(22) Filed: Dec. 20, 2017

(30) Foreign Application Priority Data
Dec. 21, 2016 (BR) 10 2016 030165 3

(51) Int. Cl. H02K 9/02

(52) U.S. Cl. CPC H02K 9/02

(57) ABSTRACT

A fastening system for the air deflector of a rotating electric machine and, more specifically, to a fastening system allowing variations in the axial position of the deflector and eliminating the need for additional fasteners. In the fastening system of the present invention, the casing has at least a portion of the inner surface configured with a plurality of axially spaced ridges, and the deflector comprises a substantially flat annular plate. The deflector has at least two resilient legs projecting from the annular plate, each leg having a shoulder sized to snap fit against a space formed between the axially spaced of the inner surface of the casing.

### FIELD OF THE INVENTION

The present invention relates to a fastening system for the air deflector of a rotating electric machine and more specifically to a fastening system which allows for variations in the axial position of the deflector and eliminates the need for additional fasteners.

### BACKGROUND OF THE INVENTION

Rotating electric machines are widely known in the art and can comprise both electric motors and electric generators. As known to those skilled in the art, electric machines typically include a ventilation system capable of dissipating the heat generated by the machine, maintaining its internal temperature within predetermined operating limits.

In rotating electric machines, the ventilation system generally comprises a fan mounted on the machine shaft and an air deflector positioned so as to direct the airflow along the inner part of the machine and especially through the stator.

In the solutions commonly found in the art, the air deflector is disposed in the motor cap, generally in a fixed position. This usual solution, however, has drawbacks.

A first drawback refers to the fixed position of the deflector, which does not allow the absorption of dimensional variations that may exist in the internal components of the machine. In the case of electric motors, for example, a dimensional variation and position variation can occur in the coil head (windings) of the motor which can lead to both a contact between the air deflector and the coil and an excessive distance, which, consequently, makes cooling difficult, causing the motor to burn, or a failure of the electrical insulating system of the motor when in contact. On the other hand, the excessive distance between the deflector and the winding, causes overheating due to the loss of cooling efficiency.

Another drawback relates to the manner of attachment between the deflector and the cap. Generally made with screws, the attachment tends to be laborious, making the assembly of the machine difficult and expensive.

Still another drawback relates to the ventilation itself: the design of the machine must ensure optimum distance between the deflector and the coil head so that there is no undesirable interference in the ventilation flow. In solutions involving fixed positioning, this requires a preliminary design that cannot be adjusted during assembly.

Some solutions known from the state of the art aim at a better assembly or interaction between the air deflector and the electric machine.

Document U.S. Pat. No. 2,512,905, for example, describes a cap and deflector assembly for an electric machine, wherein the cap has an annular flange portion with a plurality of slots at its rim and the deflector has a plurality of projections which are positioned over the slots, so that when the cap is secured to the machine housing, the deflector is held fixed between the cap and the housing. This solution, however, requires interaction between the cap and the deflector and, by proposing a fixed position, does not allow the absorption of dimensional variations that may exist in the internal components of the machine.

Document U.S. Pat. No. 2,798,974 describes an electric machine whose air deflector can be positioned in different axial positions of attachment to the cap, so as to allow its use with different rotor elements. In the solution disclosed in that document, the deflector has a flange portion with mounting holes arranged in different planes. For securing the deflector to the cap in a first position, the mounting holes are positioned in a first plane in cooperation with cap protrusions, and screws are used threaded on the protrusions and engaged in the mounting holes. In order to attach the deflector to the cap in a second position, the screw fastening is made using the mounting holes arranged in a depression (second plane) for cooperation with the protrusions of the cap.

While the solution of U.S. Pat. No. 2,798,974 provides some versatility in the positioning of the deflector, the solution shown is not simple, since the assembly requires the deflector to be turned to use the desired mounting hole and the screwing of the parts.

Document U.S. Pat. No. 2,809,307 discloses a solution similar to that of U.S. Pat. No. 2,798,974, wherein the deflector has a flange with a plurality of V-shaped beads and notches, and the cap has grooved protrusions. To mount the deflector to the cap, the flange and the cap are aligned and the deflector is rotated so that the beaded portions of the deflector—selected according to the desired position—engage corresponding grooves in the cap protrusions. The beaded portions and notches of the deflector are spaced such that, when the deflector is in the desired position, the notches align with holes in the lid. Thus, screws can pass through the holes and notches so as to perform the fixation, preventing the rotation of the deflector.

The solution of U.S. Pat. No. 2,809,307 also has drawbacks related to the need for rotation of the deflector and to the screwing of the parts.

Document U.S. Pat. No. 6,894,409 shows a ventilation solution for an electric machine, wherein the air deflector is shaped to increase the heat transfer. The deflector comprises a plate with a rim dimensioned to hold by interference to the casing, the rim having arcuate surface portions with projections, arcuate surface portions with recesses and hollow columns. The hollow columns receive threaded fasteners for fixing to the engine.

The solution shown in this document also requires a complex conformation of the deflector and the use of threaded fastening means, as well as not allowing any versatility in the axial position of the fan.

Document U.S. Pat. No. 7,157,818 describes a low noise ventilation system for an electric motor. The system comprises a fan with blades that are curved in the direction opposite to the direction of rotation of the fan, and the deflector has an annular shape, with an upstream face and a downstream face for directing air, and a rim engaging with the inner surface of the housing. Thus, the rim includes spaced flaps formed in notches of the rim and each flap has latching formation which engages a corresponding bore of the housing. The body of the deflector further includes apertures for through screws which are used to prevent the movement of the flaps and removal of the latches from the holes.

Thus, the solution disclosed in this document requires the use of latches and anchorages and also does not allow any versatility in positioning the fan.

It is an object of the present invention to provide a fastening system for an air deflector in an electric rotating machine which allows for variations in the axial position of the deflector.

It is another object of the present invention to provide a fastening system for an air deflector in an electric machine which eliminates the need for additional fasteners.

It is still another object of the present invention to provide a fastening system for an air deflector in an electric machine which is simple and safe.

### SUMMARY OF THE INVENTION

The present invention achieves these and other objects by means of a fastening system for an air deflector of an electric machine of the type comprising a casing housing an active core with a rotor and a stator, the rotor being mounted on an axis. The casing has at least a portion of its inner surface configured with a plurality of axially spaced ridges; and the deflector comprises a substantially planar annular plate. The deflector has at least two resilient legs protruding from the annular plate, each of the legs having a shoulder sized to snap fit against a space formed between the axially spaced ridges of the inner surface of the casing.

Preferably, the annular plate comprises an inner edge and an outer edge, the resilient legs protruding from the outer edge of the plate and each resilient leg comprises a curved wall leg with the shoulder disposed proximate a distal end of the curved wall. However, in alternative embodiments, each resilient leg comprises a straight wall leg with the shoulder disposed proximate a distal end of the straight wall.

In that sense, it should be understood that the shoulder of the leg may comprise any shape, and that each leg may have more than one shoulder at its distal end.

In one embodiment of the present invention, the air deflector comprises three spaced resilient legs, and the outer edge of the deflector comprises three spaced apart cut-out portions, each of the resilient legs projecting from a respective one of the three spaced apart cut-away portions.

In another embodiment of the present invention, the deflector comprises six resilient legs, the six resilient legs being distributed into three groups of two legs, the three groups being spaced apart from each other. In this embodiment, the outer edge of the deflector comprises three spaced apart cut-out portions, each of the groups of resilient legs projecting from a respective one of the three spaced apart cut-away portions.

In one embodiment of the invention, the air deflector further comprises a resilient ring which is secured to the resilient legs and resiliently shaped to press against them.

In another embodiment of the invention, the air deflector comprises at least one individual spring, the spring being configured to exert pressure on one of the resilient legs.

The present invention also relates to a rotating electric machine of the type comprising a casing housing an active core with a rotor and a stator, the rotor being mounted on an axis. The machine further comprises at least one air deflector, and the casing has at least a portion of its inner surface configured with a plurality of axially spaced ridges. The air deflector comprises a substantially flat annular plate, the air deflector having at least two resilient legs protruding from the annular plate, each of the legs having a shoulder sized to snap fit against a space formed between the axially spaced ridges of the inner surface of the casing.

In embodiments of the invention, each resilient leg comprises a curved or straight wall leg with the shoulder disposed proximate a distal end of the curved wall, the deflector preferably comprising three spaced apart resilient legs.

In other embodiments, each resilient leg comprises a curved or straight wall leg with the shoulder disposed proximate a distal end of the curved wall, the deflector comprising six resilient legs, with the six resilient legs being distributed in three spaced groups with two legs.

It will be understood that the shoulder of the leg may have any shape, and that each leg may have more than one shoulder.

### BRIEF DESCRIPTION OF THE DRAWINGS

FIG. 1 is a cross-sectional view of an electric motor incorporating the fastening system according to the present invention;

FIG. 2 is an enlarged detail view of the inner surface of the electric motor casing;

FIG. 3 is a front perspective view of the air deflector of the fastening system according to a first embodiment of the present invention;

FIG. 4 is a rear perspective view of the air deflector of the fastening system according to the first embodiment of the present invention;

FIG. 5 is a front perspective view of the air deflector of the fastening system according to a second embodiment of the present invention;

FIG. 6 is a rear perspective view of the air deflector of the fastening system according to the second embodiment of the present invention;

FIG. 7 is an enlarged detail view of the inner surface of the casing of an electric motor with the fastening system according to the second embodiment of the present invention;

FIG. 8 is a front perspective view of the air deflector of the fastening system according to a third embodiment of the present invention;

FIG. 9 is a rear perspective view of the air deflector of the fastening system according to the third embodiment of the present invention;

FIG. 10 is a front perspective view of the air deflector of the fastening system according to a fourth embodiment of the present invention;

FIG. 11 is a rear perspective view of the air deflector of the fastening system according to the fourth embodiment of the present invention;

FIG. 12 is a front perspective view of the air deflector of the fastening system according to a fifth embodiment of the present invention;

FIG. 13 is a rear perspective view of the air deflector of the fastening system according to the fifth embodiment of the present invention;

FIG. 14 is a front perspective view of the air deflector of the fastening system according to a sixth embodiment of the present invention; and

FIG. 15 is a rear perspective view of the air deflector of the fastening system according to the sixth embodiment of the present invention.

### DETAILED DESCRIPTION OF THE INVENTION

The present invention will now be described based on examples of preferred embodiments of the system according to the present invention.

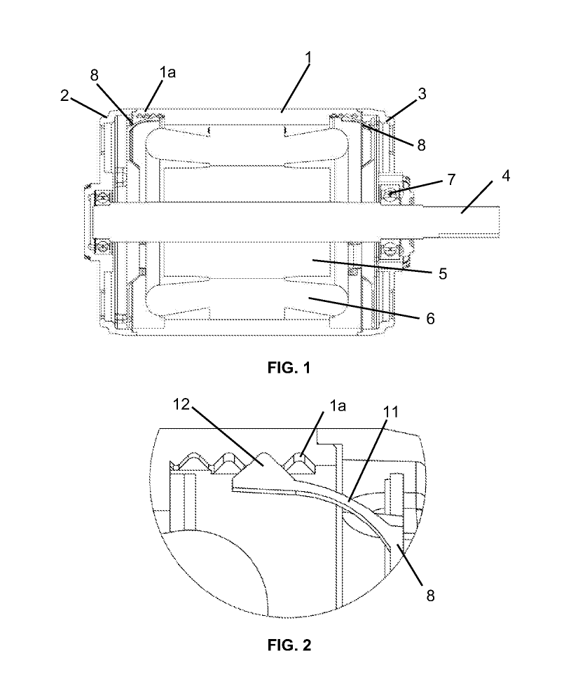

FIGS. 1 to 4 illustrate a first embodiment of the fastening system of the present invention.

FIG. 1 shows a cross-sectional view of an electric motor incorporating the fastening system according to the first embodiment of the present invention.

Although the present description is written with reference to an electric motor, it should be understood that the fastening system of the present invention could be applied to any rotating electric machine utilizing a casing and an air deflector.

As can be seen in FIG. 1, the casing comprises a central body 1 which is closed by two end caps 2 and 3. The caps may be fixed to the central body as shown in the figure or integrally formed with a bipartite central body. Preferably, the casing is made of cast iron, however, other suitable materials could be used.

The casing houses an active core with a rotor 5 and a stator 6, the rotor 5 being arranged on a rotating shaft 4, supported by bearings 7. The construction of such an active core is known to those skilled in the art and, therefore, will not be detailed here.

The inner surface of the casing 1 has at least one portion configured with axially spaced ridges 1a.

The ridges may be formed by embossed portions or depressed portions, and may have a height of between about 1 mm and about 10 mm. The angle between ribbed regions may range from about 30 to about 130 degrees.

The electric machine has at least one air deflector 8, which is preferably made of a polymeric material. In embodiments of the present invention, the deflector 8 is formed of polyamide 66 with 15% glass fiber, however, in alternative embodiments, the deflector could be fabricated from another material, such as steel, or even a combination of materials, with polymeric body and steel legs, or vice versa.

In the embodiment of the invention shown in the figures, the electric motor has two air deflectors 8, each deflector 8 disposed on one side of the active core of the motor.

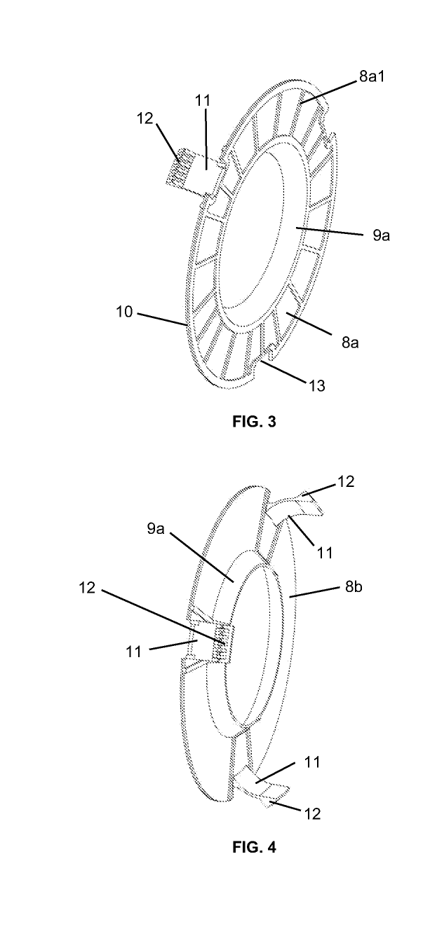

As can be seen in FIGS. 3 and 4, in a first embodiment, the air deflector 8 comprises a substantially flat annular plate with an inner edge 9 and an outer edge 10.

The plate has a front surface 8a and a back surface 8b.

It should be noted that the terms “front” and “rear” as used herein consider the view in FIG. 3 and not the manner in which the deflector is located in the machine.

As can be seen in FIG. 1, in the preferred embodiment of the present invention, both the air deflector positioned to the left of the active core and the air deflector positioned to the right of the active core have the back surface facing the active core.

The front surface 8a of the annular plate may comprise radial shoulders 8a1 acting as reinforcements.

The inner edge 9 of the plate has a wall 9a which projects slightly sloping towards the geometric center of the edge.

The wall 9a functions as a nozzle or diffuser which directs the flow of the air stream, improving the cooling of the active core.

The air deflector has at least two resilient legs 11 protruding from the annular plate, and preferably from its outer edge 10. In the embodiment shown in FIGS. 3 and 4, the deflector has three spaced resilient legs.

Naturally, the invention would be equally functional with a different number of legs 11, such as, for example, two, four, five or more legs.

Each of the legs 11 has a shoulder 12 dimensioned to press against a space formed between the axially spaced ridges 1a of the inner surface of the casing (shown in an enlarged version in FIG. 2).

Preferably, the resilient characteristic of the legs 11 is due to the conformation/shaping of the leg as a curved wall. So that, when fitting the deflector inside the casing, the legs press the inner surface of the casing with a spring action. However, in alternative embodiments of the invention, the legs may be flat or there may be additional elements to enhance the spring effect.

Since there are a plurality of ridges 1a formed in the casing 1, the axial position of the deflector can be varied by simply selecting the space between ribs on which the shoulders 12 of the legs 11 will be pressed against.

In preferred embodiments of the present invention, the shoulder 12 is disposed proximate a distal end of the curved wall, so as to increase the spring force.

The term “shoulder” as used in the present description comprises protuberances of any size and shape, provided that they can be pressed against a space formed between the axially spaced ridges 1a of the inner surface of the casing 1. Naturally, each leg may also have more than one shoulder at its distal end.

As shown in FIGS. 3 and 4, the outer edge of the deflector may comprise cut-out portions 13, each leg 11 projecting from a respective one of the cut-out portions 13.

The cutouts in the cut-out portions 13 help prevent contact with the fixing screw of the closure cap of the casing. Naturally, such cutouts are optional and could not be present in alternative embodiments of the invention.

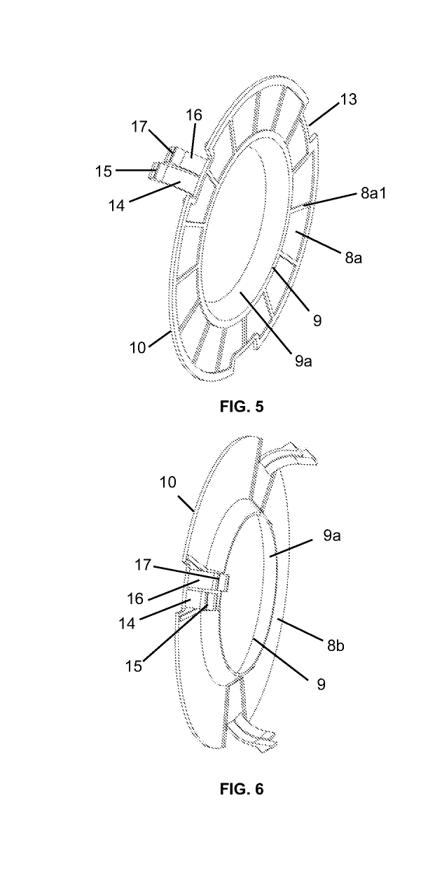

FIGS. 5 to 7 show a second embodiment of the fastening system of the present invention. In this embodiment, the characteristics of the casing 1 are the same as described with respect to the first embodiment.

The characteristics of the air deflector are also identical to that of the deflector of the first embodiment, except for the legs. Thus, FIGS. 5 to 7 use the same reference numbers for the identical characteristics of the deflector shown in FIGS. 1 to 4, but different reference numbers for different characteristics.

In the second embodiment, the deflector comprises six resilient legs, which are distributed into three spaced apart groups with two legs 14, 16. Preferably, the three groups are spaced equidistantly.

Each leg 14, 16 has a shoulder 15, 17. Thus, for the positioning of the deflector, the shoulders 15, 17 are pressed against the corresponding spaces between the ridges 1a of the inner surface of the casing 1.

Also in the second embodiment, the outer edge of the deflector comprises three cutouts 13, each of the groups of resilient legs projecting from a respective one of the three cutouts.

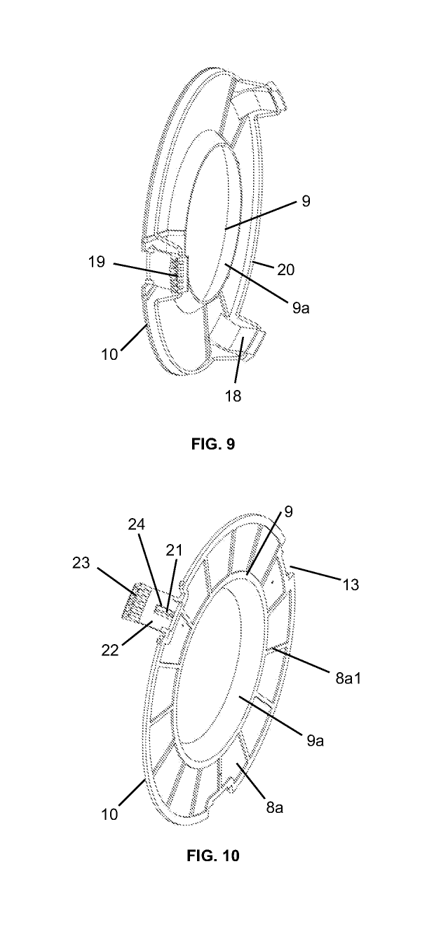

FIGS. 8 and 9 show a third embodiment of the fastening system of the present invention. In this embodiment, the characteristics of the casing 1 are the same as those described with respect to the first embodiment.

The characteristics of the air deflector are also identical to that of the deflector of the first embodiment, except for the legs and the presence of a resilient ring 20. Thus, FIGS. 8 and 9 use the same numbering for the identical characteristics of the deflector shown In FIGS. 1 to 4, but different reference numbers for the different characteristics.

In the third embodiment, the deflector comprises three legs 18 with a shoulder 19 at the end, similarly to the first embodiment. The deflector of the third embodiment further comprises a resilient ring 20. The ring is fitted to each rear surface, i.e., to the surface opposite the surface on which the shoulder 19 is located, of each of the legs 18.

It should be noted that the ring 20 may be continuous or formed by rim segments with the ends secured (for example, engaged) to the legs 18 of the deflector.

This resilient ring 20 exerts pressure on the legs 18, increasing the spring effect and hence the resilience of the legs for snap engagement of the deflector. The material of the resilient ring 20 is preferably metallic.

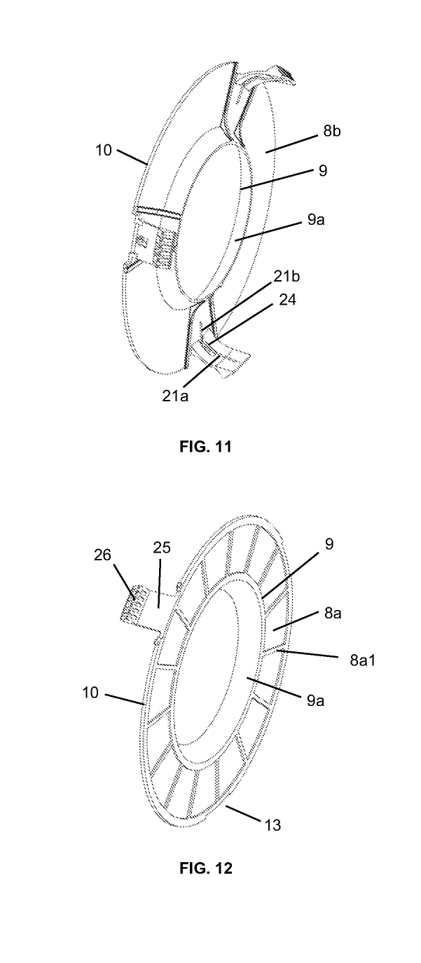

FIGS. 10 and 11 show a fourth embodiment of the invention, wherein the resilient ring 20 is replaced by individual springs 21 on each leg. FIGS. 10 and 11 use the same numbering for the identical characteristics of the deflector shown in FIGS. 1 to 4, but different reference numbers for different characteristics.

In the embodiment of these figures, the deflector comprises three legs 22, each with a shoulder 23. The body of each leg 21 has a slot 24 for installation of the spring 21. Thus, the spring 21 is installed so that one first leg 21a presses the back surface of the leg and the other leg 21b presses the surface 8b of the flat plate of the deflector. The term “back surface of the leg” indicates the surface opposite the surface on which the shoulder 23 is located.

Thus, each of the springs 21 presses on a respective of the legs 22 increasing the spring effect, and therefore the resilience of the legs for snap engagement of the deflector.

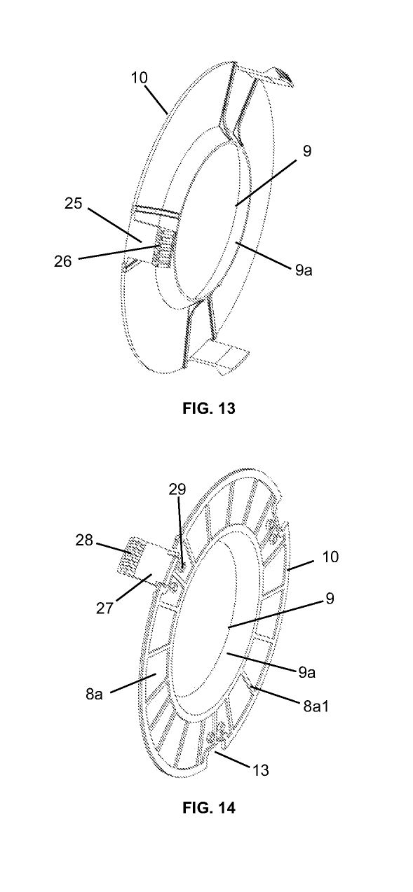

FIGS. 12 and 13 show a fifth embodiment of the invention, wherein the legs are straight and not curved. In this embodiment, the characteristics of the casing 1 are the same as described with respect to the first embodiment.

The characteristics of the air deflector are also identical to that of the deflector of the first embodiment, except for the legs 25. Thus, FIGS. 12 and 13 use the same numbering for the identical characteristics of the deflector shown in FIGS. 1 to 4, but different reference numbers for different characteristics.

In the fifth embodiment of the invention, the deflector comprises three substantially straight resilient legs 25 which protrude approximately perpendicularly from the annular deflector plate, preferably from its outer edge. Each of the legs 25 has a shoulder 26 dimensioned to snap fit against a space formed between the axially spaced ridges 1a of the inner surface of the casing.

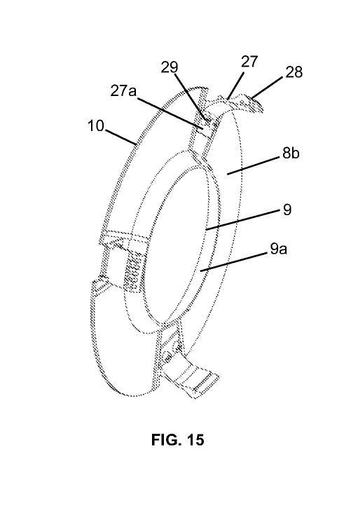

FIGS. 14 and 15 show a fifth embodiment of the invention, wherein the legs are straight and not curved. In this embodiment, the characteristics of the casing 1 are the same as described with respect to the first embodiment.

The characteristics of the air deflector are also identical to that of the deflector of the first embodiment, except for the attachment between the legs and the deflector body. Thus, FIGS. 14 and 15 use the same numbering for the identical characteristics of the deflector shown in FIGS. 1 to 4, but different reference numbers for different characteristics.

In the sixth embodiment of the invention, the deflector comprises curved legs 27 with shoulders 28. Each of the legs further comprises a flap 27a that is disposed adjacent the substantially flat plate of deflector 8, so that at least one fastening member, as by way of example a screw 29, rivet or an adhesive means, may be used to secure the flap 27a to the deflector 8.

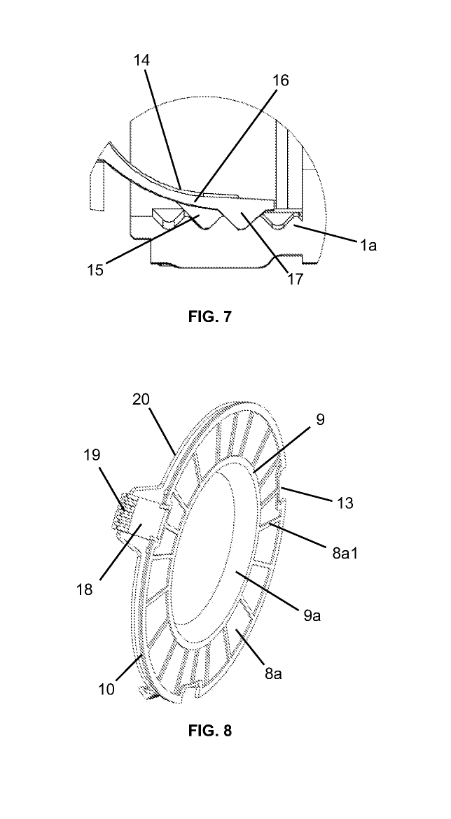

It should be noted that the resilient ring 20 of the third embodiment and the individual springs 21 of the fourth embodiment could also be used with the straight legs of the fifth embodiment. In addition, the embodiments shown in FIGS. 7 to 15 could include deflectors with a different number of legs, without prejudice to the inventive concept proposed herein; and the attachment between the legs and the substantially flat plate of the deflector can be performed in any suitable manner, such as, for example, a locking fixture, a one-piece forming or a screw fixing.

It is also to be understood that although in the embodiments shown in the figures, the resilient legs of the deflector are projected substantially perpendicular to the plane of the annular plate, they could project slopingly or even in a substantially parallel plane to the plane of the plate, without departing from the inventive concept of the present invention.

Thus, having described examples of embodiments of the present invention, it is to be understood that the scope of the present invention encompasses other possible variations of the inventive concept described, being limited only by the content of the appended claims, including possible equivalents thereto.

1. A fastening system for an air deflector of a rotating electric machine of the type comprising a casing housing an active core with a rotor and a stator, the rotor being mounted on an axis; wherein characterized in that:
the casing has at least a portion its inner surface configured with a plurality of axially spaced ridges;
the deflector comprises a substantially flat annular plate, the deflector having at least two resilient legs projecting from the annular plate, each of the legs having a shoulder sized to snap fit against a space formed between the axially spaced ridges of the inner surface of the casing.

2. The fastening system according to claim 1, characterized in that the plate comprises an inner edge and an outer edge, the resilient legs protruding from the outer edge of the annular plate.

3. The fastening system according to claim 1, characterized in that each resilient leg comprises a curved wall leg with the shoulder disposed proximate a distal end of the curved wall.

4. The fastening system according to claim 1, characterized in that each resilient leg comprises a straight wall leg with the shoulder disposed proximate a distal end of the curved wall.

5. The fastening system according to claim 1, characterized in that the deflector comprises three spaced apart resilient legs.

6. The fastening system according to claim 5, characterized in that the outer edge of the deflector comprises three cut-out portions, each of the resilient legs projecting from a respective one of the three cut-out portions.

7. The fastening system according to claim 1, characterized in that the deflector comprises six resilient legs, the six resilient legs being distributed in three groups of two legs, the three groups being spaced equidistantly.

8. The fastening system according to claim 7, characterized in that the outer edge of the deflector comprises three spaced cut-out portions, each of the groups of resilient legs projecting from a respective one of the three cut-out portions.

9. The fastening system according to claim 1, characterized in that the air deflector further comprises a resilient ring which is secured to the resilient legs and configured to exert pressure thereon.

10. The fastening system according to claim 1, characterized in that the air deflector comprises at least one individual spring in one of the resilient legs, the spring being configured to press against the resilient leg in which it is located.

11. A rotating electric machine of the type comprising a casing housing an active core with a rotor and a stator, the rotor being mounted on an axis, the machine comprising at least one air deflector air and being characterized by the fact that:
the casing has at least a portion of the inner surface configured with a plurality of axially spaced ridges;
the air deflector comprises a substantially flat annular plate, the deflector having at least two resilient legs projecting from the annular plate, each of the legs having a shoulder of the inner surface of the casing.

12. The rotating electric machine according to claim 11, characterized in that the annular plate comprises an inner edge and an outer edge, and the resilient legs protrude from the outer edge of annular plate.
